(19) United States
(12) Patent Application Publication
(10) Pub. No.: US 2024/0182022 A1
(43) Pub. Date: Jun. 6, 2024

(54) PREVENTIVE SAFETY DEVICE AND VEHICLE

(71) Applicant: TOYOTA JIDOSHA KABUSHIKI KAISHA, Toyota-shi (JP)

(72) Inventor: Sho HASHIMOTO, Susono-shi (JP)

(73) Assignee: TOYOTA JIDOSHA KABUSHIKI KAISHA, Toyota-shi (JP)

(21) Appl. No.: 18/468,770

(22) Filed: Sep. 18, 2023

(30) Foreign Application Priority Data
Dec. 1, 2022 (JP) 2022-193044

(51) Int. Cl. B60W 30/09; B60W 30/095; B60W 60/00

(52) U.S. Cl. CPC B60W 30/09; B60W 30/0956; B60W 60/0015; B60W 2554/80

(57) ABSTRACT

A preventive safety device has a preventive safety function. The preventive safety device includes one or more processors that: receive an input of a driving signal from an automatic driving device that performs automatic driving of a vehicle; determine whether the first operating condition is satisfied; determine, based on the driving signal, whether the automatic driving device has an intention to perform vehicle control that causes establishment of the first operating condition, an intention to perform vehicle control that eliminates establishment of the first operating condition, or an intention to stop the preventive safety function; when the automatic driving device does not have any of the intentions, activate the preventive safety function in response to establishment of the first operating condition; and when the automatic driving device has any of the intentions, activate the preventive safety function in response to establishment of the second operating condition.

### CROSS-REFERENCE TO RELATED APPLICATION

This application claims priority to Japanese Patent Application No. 2022-193044 filed on Dec. 1, 2022 incorporated herein by reference in its entirety.

### BACKGROUND

### 1. Technical Field

The present disclosure relates to a technique for performing control related to preventive safety of a vehicle.

### 2. Description of Related Art

Japanese Unexamined Patent Application Publication No. 2021-059327 (JP 2021-059327 A) discloses a method of shifting from an autonomous driving mode to a manual driving mode in an autonomous driving vehicle. In the method, whether the transition from the autonomous driving mode to the manual driving mode is permitted is determined from the location or the driving scenario, and when the transition is permitted, the transition to the manual driving mode is performed.

### SUMMARY

An autonomous driving vehicle that travels by autonomous driving is known. A preventive safety device is also known in which, when a predetermined operating condition is satisfied, a preventive safety function is activated to intervene in driving of a driver, and control of a vehicle for avoiding danger is performed. Consider the application of such a preventive safety device to an autonomous vehicle. If the preventive safety function is always activated to intervene in the autonomous driving when the same operating condition as that at the time of the manual driving by the driver is satisfied, there is a possibility that the traveling plan for the autonomous driving is hindered. However, if the preventive safety function is not activated at all during autonomous driving, the preventive safety effect of avoiding the danger cannot be sufficiently obtained. Therefore, it is required to perform appropriate arbitration between autonomous driving of the vehicle and control for preventive safety.

An object of the present disclosure is to provide a technique capable of appropriately arbitrating autonomous driving of a vehicle and control for preventive safety.

A first aspect relates to a preventive safety device having a preventive safety function for control for preventive safety of a vehicle. The preventive safety device includes one or more processors. The one or more processors receive an input of a driving signal from an autonomous driving device for performing autonomous driving of the vehicle, determine whether a first operating condition for activating the preventive safety function is satisfied, determine, based on the driving signal, whether the autonomous driving device has an intention to perform vehicle control causing satisfaction of the first operating condition, whether the autonomous driving device has an intention to perform vehicle control to eliminate the satisfaction of the first operating condition, or whether the autonomous driving device has an intention to stop the preventive safety function, activate the preventive safety function in response to the satisfaction of the first operating condition, when the autonomous driving device does not have any of the intentions, and activate the preventive safety function in response to satisfaction of a second operating condition that is more severe than the first operating condition, when the autonomous driving device has any of the intentions.

As a second aspect, in the preventive safety device according to the first aspect, the control for the preventive safety may be to control steering of the vehicle to suppress lane departure of the vehicle. Further, at this time, the intention of the autonomous driving device to perform the vehicle control causing the satisfaction of the first operating condition may be an intention of steering for lane change.

As a third aspect, in the preventive safety device according to the first aspect, the control for the preventive safety may be to decelerate the vehicle to avoid collision of the vehicle.

Further, at this time, the intention of the autonomous driving device to perform the vehicle control to eliminate the satisfaction of the first operating condition may be an intention of steering or deceleration for avoiding an obstacle.

As a fourth aspect, in the preventive safety device according to the third aspect, the first operating condition may be that a collision margin time of the vehicle is smaller than a first threshold value, and the second operating condition may be that the collision margin time is smaller than a second threshold value. The second threshold value is smaller than the first threshold value.

A fifth aspect relates to a vehicle including: the preventive safety device according to any one of the first to fourth aspects; and an interface for receiving an input of the driving signal from the autonomous driving device.

According to the present disclosure, it is possible to appropriately arbitrate autonomous driving of a vehicle and control by preventive safety.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a vehicle according to the present embodiment;

FIG. 2 is a flowchart illustrating an example of a process executed by the preventive safety device according to the present embodiment;

FIG. 3 is a table showing a specific example of the driving intention of the automatic driving apparatus;

FIG. 4 is a conceptual diagram illustrating an example of a scene to which the processing according to the present embodiment is applied; and

FIG. 5 is a conceptual diagram illustrating another example of a scene to which the processing according to the present embodiment is applied.

### DETAILED DESCRIPTION OF EMBODIMENTS

Embodiments of the present disclosure will be described with reference to the accompanying drawings.

### 1. Configuration of the Vehicle

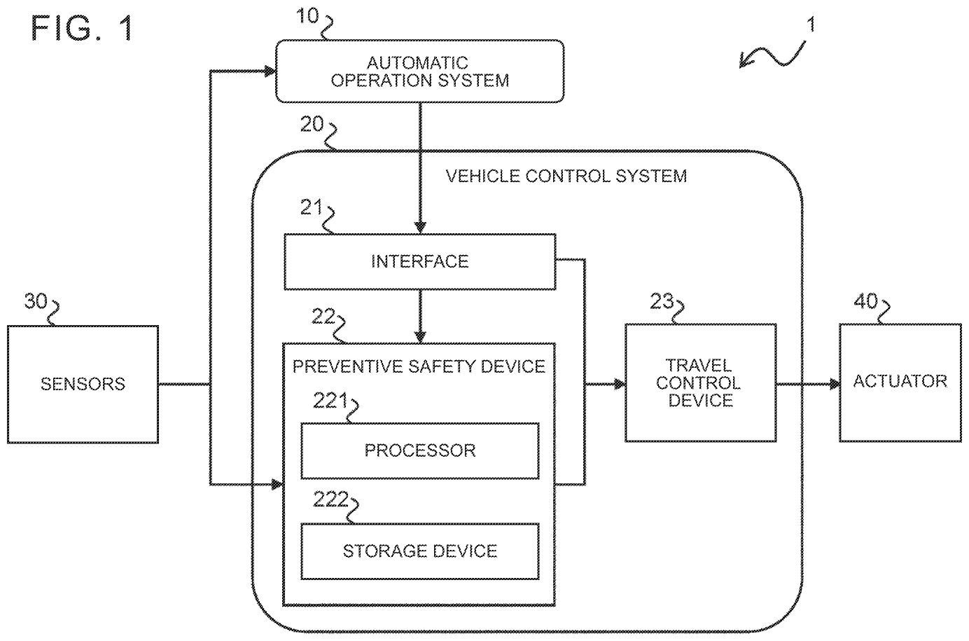

FIG. 1 is a diagram illustrating an example of a configuration of a vehicle 1 according to the present embodiment. The vehicle 1 includes an autonomous driving device 10, a vehicle control system 20, sensors 30, and an actuator 40. The autonomous driving device 10, the vehicle control system 20, the sensors 30, and the actuator 40 are mounted on the vehicle 1. However, at least a part of the autonomous driving device 10 and the vehicle control system 20 may be disposed in an external device outside the vehicle 1, and may control the vehicle 1 remotely. That is, the autonomous driving device 10 and the vehicle control system 20 may be distributed between the vehicle 1 and the external device.

The autonomous driving device 10 performs autonomous driving of the vehicle 1. The autonomous driving device 10 is, for example, an Electronic Control Unit (ECU) that can be retrofitted to the vehicles 1. Alternatively, the autonomous driving device may be a device fixed to the vehicle 1. The autonomous driving device 10 may be included in the vehicle control system 20. The autonomous driving performed by the autonomous driving device 10 is assumed to be an autonomous driving at a level 4 or higher without assuming the presence of drivers, for example, in defining the level of Society of Automotive Engineers (SAE).

The autonomous driving device 10 acquires sensor information from the sensors 30. The sensors 30 include a recognition sensor, a vehicle state sensor, and a position sensor. The recognition sensor recognizes (detects) a situation around the vehicle 1. Examples of the recognition sensor include a camera, a millimeter-wave radar, and a Laser Imaging Detection and Ranging (LIDAR. The vehicle state sensor detects a state of the vehicle 1. The vehicle state sensor includes a speed sensor, an acceleration sensor, a yaw rate sensor, a steering angle sensor, and the like. The position sensor detects a position and an azimuth of the vehicle 1. Examples of the position sensor include a Global Positioning System (GPS) sensor.

The sensor information acquired by the autonomous driving device 10 from the sensors 30 includes recognition sensor information acquired by the recognition sensor, vehicle state information acquired by the vehicle state sensor, and position information acquired by the position sensor. The sensors 30 may include sensors other than a recognition sensor, a vehicle state sensor, and a position sensor.

The autonomous driving device 10 formulates a traveling plan of the vehicle 1 using the acquired sensor information. The travel plan is designed to cause the vehicle 1 to travel along an optimal route to the destination while following traffic rules. In the planning of the travel plan, in addition to the sensor information, map information stored in advance by the autonomous driving device 10 or provided by a management server that manages automatic driving of the vehicle 1 may be used. The travel plan includes operations such as maintaining the current travel lane, changing the lane, and the like. Then, the autonomous driving device 10 generates a target trajectory necessary for the vehicle 1 to travel in accordance with the travel plan based on the recognition sensor information included in the sensor information. The target trajectory includes a set of target positions of the vehicle 1 in the road on which the vehicle 1 travels and a target speed for each target position.

The autonomous driving device 10 calculates a deviation (a lateral deviation, a yaw angle deviation, a speed deviation, and the like) between the vehicle 1 and the target trajectory in order to cause the generated target trajectory to follow the vehicle 1. The autonomous driving device 10 controls steering, braking, and driving of the vehicle 1 so that a deviation between the vehicle 1 and the target trajectory is reduced. The autonomous driving device 10 also operates a device such as a winker mounted on the vehicle 1 as necessary. For example, when a lane change is included in the travel plan, the autonomous driving device 10 controls the steering of the vehicle 1 so as to follow the target trajectory while operating the winker. These controls and operations are performed by the autonomous driving device 10 outputting a “driving signal” to the vehicle control system 20, and the travel control device 23, which will be described later, operates the actuator 40 in response to the driving signal. The driving signal is a signal including a control request for requesting control of steering, braking, or driving of the vehicle 1, and an operation request related to an operation of a winker or the like, and is input to the vehicle control system 20.

The vehicle control system 20 includes an interface 21, a preventive safety device 22, and a travel control device 23. The devices included in the vehicle control system may each be configured by a single ECU.

The preventive safety device 22 has a preventive safety function for the preventive safety of the vehicle 1. The preventive safety device 22 comprises one or more processors 221 (hereinafter simply referred to as processors 221) and one or more storage devices 222 (hereinafter simply referred to as storage devices 222). The processor 221 executes various processes. The storage device 222 stores various programs and various data. When the processor 221 executes the program stored in the storage device 222, various kinds of processing by the preventive safety device 22 including processing for activating the preventive safety function are realized.

The interface 21 is an interface for receiving an input of an operation signal output from the autonomous driving device 10. The driving signal may include an override request and a driving mode signal in addition to the control request and the operation request. The override request is a signal for requesting the autonomous driving device 10 to stop the preventive safety function. The driving mode signal is a signal indicating a driving mode such as a manual driving mode in which manual driving by the driver is performed or an automatic driving mode in which automatic driving by the autonomous driving device 10 is performed. The operation signal received by the interface 21 is input to the preventive safety device 22 and the travel control device 23.

The preventive safety device 22 receives an input of an operation signal from the autonomous driving device 10 via the interface 21. In addition, the preventive safety device 22 acquires sensor information from the sensors 30 for the preventive safety of the vehicle 1. The sensor information acquired by the preventive safety device 22 includes at least recognition sensor information.

The preventive safety function is a function for supporting driving by controlling the vehicle 1 so as to avoid danger to the vehicle 1. The preventive safety device 22 activates the preventive safety function when a predetermined condition is satisfied, and controls steering, braking, or both of the vehicle 1 by intervening in manual driving or automatic driving. As used herein, the term “danger to the vehicle 1” means a danger that can be detected by the sensors 30 and avoided by the control of the vehicle 1. Typical examples are collisions with obstacles and deviations from the lane in which the vehicle 1 travels. The preventive safety device 22 activates the preventive safety function when a situation in which these hazards may occur is detected from the sensor information, in particular the recognition sensor information.

For example, when a situation in which a collision with an obstacle may occur is detected, the collision avoidance control is activated. When the collision avoidance control is activated, braking of the vehicle 1 is controlled to avoid collision of the vehicle 1, and the vehicle 1 is decelerated. Here, the obstacle includes an object, a person, another vehicle, and the like existing in the vicinity of the road. The obstacle is detected by a recognition sensor. The speed of the vehicle 1 is obtained from a vehicle state sensor. When the collision margin time (TTC) to the obstacle becomes less than the first threshold value, it is determined that there is a possibility that a collision with the obstacle may occur.

Further, when a situation in which the vehicle 1 may deviate from the lane is detected, the lane deviation suppression control is activated. For example, a white line around the vehicle 1 is detected by a recognition sensor (e.g., a camera), and a margin distance between the vehicle 1 and the white line is calculated. As another example, the margin distance between the vehicle 1 and the white line is acquired from the position of the white line registered in the map information and the position information of the vehicle 1. Further, the margin distance and the deviation allowance time from the speed of the vehicle 1 may be calculated. When the margin distance or the deviation allowance time falls below the threshold value, it is determined that the vehicle 1 may deviate from the lane. When the lane departure suppression control is activated, the steering of the vehicle 1 is controlled so that the vehicle 1 is directed toward the lane center direction in order to suppress the lane departure of the vehicle 1.

Such control of the vehicle 1 by the preventive safety device 22 is performed by the travel control device 23 operating the actuator 40 in response to a control request output from the preventive safety device 22.

A control request and an operation request from the autonomous driving device 10 via the interface 21 and a control request from the preventive safety device 22 are input to the travel control device 23. The control request from the autonomous driving device includes an acceleration request, a deceleration request, and a steering request. The control request from the preventive safety device 22 includes a deceleration request and a steering request. The travel control device 23 operates the actuator 40 in response to an input control request or operation request. The actuator 40 includes a steering actuator for steering the wheels of the vehicle 1, a driving actuator for driving the vehicle 1, a braking actuator for braking the vehicle 1, and an actuator for operating a winker.

When a request is input from both the autonomous driving device 10 and the preventive safety device 22, the travel control device 23 selects which request is preferentially adopted, and operates the actuator 40 according to one of the requests. The method of selection can be arbitrarily set, but the input of a control request from the preventive safety device 22 is usually prioritized. The preventive safety device 22 can intervene in the automatic operation by operating the actuator 40 in accordance with a control request from the preventive safety device 22 that is prioritized to the request from the autonomous driving device 10. In this way, the automatic driving by the autonomous driving device 10 and the control of the vehicle 1 by the preventive safety function are performed. 2. Arbitration of automatic driving and preventive safety

Here, the condition in which the preventive safety function intervenes in the automatic driving is considered. If the preventive safety device 22 activates the preventive safety function whenever a certain condition is satisfied and intervenes in the automatic driving, there is a possibility that the travel plan of the autonomous driving device 10 is hindered. However, if the preventive safety function is not operated at all during the automatic driving, there is a possibility that the safety of the traveling of the vehicle 1 is not sufficiently protected. Therefore, the automatic driving function and the preventive safety function need to be appropriately arbitrated. According to the preventive safety device 22 according to the present embodiment, it is possible to perform appropriate arbitration between the automatic driving by the autonomous driving device 10 and the preventive safety function of the preventive safety device 22. In order to achieve appropriate arbitration, the preventive safety device 22 determines whether or not the autonomous driving device 10 has “driving intention”. The preventive safety device 22 changes the operating condition for activating the preventive safety function according to whether or not the autonomous driving device 10 intends to operate.

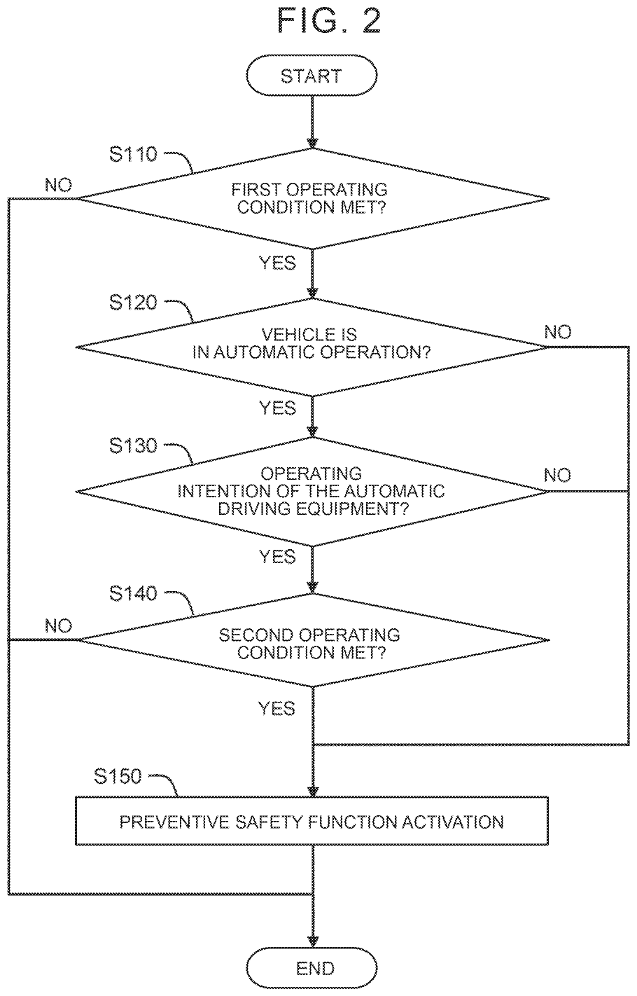

FIG. 2 is a flowchart illustrating an example of a process performed by the preventive safety device 22. This process is repeatedly executed in a predetermined control cycle. This processing is realized by the processor 221 executing a program stored in the storage device 222. Operation conditions will be described with reference to the flowchart of FIG. 2.

In S110, the preventive safety device 22 (processor 221) determines whether or not the “first operating condition” is satisfied. When the first operating condition is satisfied (S110;Yes), the process proceeds to S120. On the other hand, when the first operating condition is not satisfied (S110;No), the process in the present cycle ends.

The first operating condition is a normal condition for activating the preventive safety function. The first operating condition may be the same as the operating condition of the preventive safety function during manual operation. The collision allowance time, the deviation allowance time, and the like are used for determining the establishment of the first operating condition. For example, the first operating condition for the collision avoidance control may be that the collision margin time of the vehicle 1 is less than the first threshold value. Further, for example, the first operating condition for the lane departure suppression control may be that the margin distance or the departure margin time with respect to the white line becomes equal to or less than the threshold value. The preventive safety device 22 can determine the establishment of the first operating condition based on the sensor information acquired from the sensors 30.

In S120, the processor 221 determines whether or not the vehicle 1 is in autonomous driving. When the vehicle 1 is in autonomous driving (S120;Yes), the process proceeds to S130. On the other hand, when the vehicle 1 is not in autonomous driving (S120;No), the process proceeds to S150.

The processor 221 can determine whether or not the vehicle 1 is in autonomous driving based on a driving signal output from the autonomous driving device 10. The processor 221 may determine whether or not the vehicle 1 is autonomously driving based on the driving mode signal. Alternatively, the processor 221 may determine that the vehicle 1 is in autonomous driving when a control request is output from the autonomous driving device 10, and may determine that the vehicle is not in autonomous driving otherwise. As yet another example, the processor 221 may acquire information related to an operation of steering, accelerator pedal, brake pedal, or the like by the driver of the vehicle 1 from the actuator 40, or acquire information from a seating sensor or the like, and determine that the vehicle is in automatic driving when the driver does not operate the vehicle 1 or when the driver is not riding on the vehicle 1.

In S130, the processor 221 determines whether the autonomous driving device 10 has a driving intention. If the autonomous driving device 10 has a driving intent (S130;Yes), the process proceeds to S140. On the other hand, when the autonomous driving device 10 has no driving intent (S130;No), the process proceeds to S150.

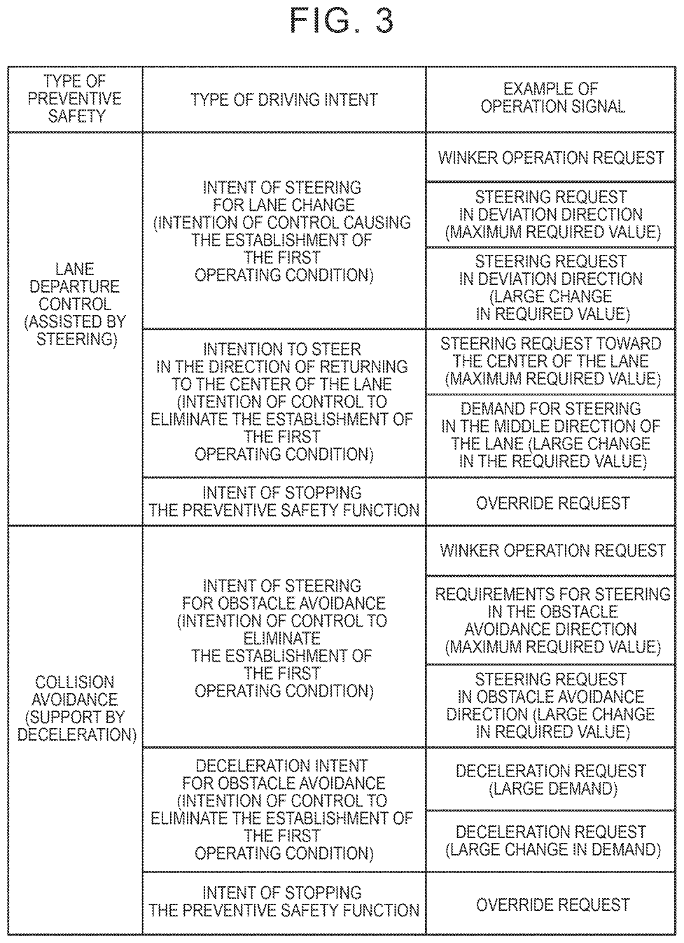

The processor 221 determines whether the autonomous driving device 10 has a driving intention based on the driving signal. FIG. 3 is a table showing a specific example of a driving signal indicating that the autonomous driving device 10 has a driving intention. The driving intention is an intention to perform vehicle control that causes the establishment of the first operating condition by the autonomous driving device 10, an intention to perform vehicle control that eliminates the establishment of the first operating condition, or an intention to stop the preventive safety function.

First, an operation intent when the preventive safety function corresponding to the first operation condition determined to be satisfied in S110 is the lane departure suppressing control will be described. The intention of performing the vehicle control causing the establishment of the first operating condition is the intention of changing the lane of the vehicle 1. This is because when the autonomous driving device 10 tries to change the lane of the vehicle 1, the vehicle 1 is controlled to travel in a direction deviating from the lane. The intention of changing the lane of the vehicle 1 is expressed in the driving signal as a winker operation request, a steering request in a direction deviating from a lane in which the requested steering angle is larger than the threshold, or a steering request in a direction deviating from a lane in which the change speed of the requested steering angle is higher than the threshold.

Although not shown in the table, the intention of performing the vehicle control that causes the establishment of the first operating condition may further include an intention of causing the vehicle 1 to overtake. The driving signal indicating the intention of causing the vehicle 1 to overtake is the same as the driving signal indicating the intention of changing the lane of the vehicle 1.

Further, the intention of performing the vehicle control to eliminate the establishment of the first operating condition is the intention of steering in the lane center direction. This is because, if the autonomous driving device 10 steers the vehicle 1 in a direction to return to the center of the lane itself, the risk of deviation from the lane is eliminated. The intention of steering in the lane center direction is expressed in the driving signal as a steering request in the lane center direction in which the required steering angle is larger than the threshold value, or a steering request in the lane center direction in which the change speed of the required steering angle is higher than the threshold value.

Further, an intention of stopping the preventive safety function by the autonomous driving device 10 appears as an override request. When at least one of the above-described requests is included in the driving signal that has received the input from the autonomous driving device 10, the processor 221 determines that the autonomous driving device 10 has the driving intention. Conversely, when the driving signal does not include any of the above-described requests, the processor 221 determines that the autonomous driving device 10 has no driving intention.

Next, an operation intent when the preventive safety function corresponding to the first operation condition determined to be satisfied in S110 is the collision-avoidance control will be described. The intention of performing the vehicle control for eliminating the establishment of the first operating condition is to steer or decelerate the vehicle 1 in order to avoid an obstacle. The intention of steering the vehicle 1 in order to avoid an obstacle is expressed as an operation request of a winker, a steering request in a direction in which a required steering angle avoids an obstacle larger than a threshold value, or a steering request in a direction in which a change speed of the required steering angle avoids an obstacle higher than the threshold value. The intention of decelerating the vehicle 1 in order to avoid an obstacle appears in the driving signal as a deceleration request in which the required amount is larger than the threshold value or a deceleration request in which the change speed of the required amount is higher than the threshold value.

Further, an intention of stopping the preventive safety function by the autonomous driving device 10 appears as an override request. When at least one of the above-described requests is included in the driving signal that has received the input from the autonomous driving device 10, the processor 221 determines that the autonomous driving device 10 has the driving intention. Conversely, when the driving signal does not include any of the above-described requests, the processor 221 determines that the autonomous driving device 10 has no driving intention.

Referring back to FIG. 2, in S140, the processor 221 determines whether the second operating condition is satisfied. When the second operating condition is satisfied (S140;Yes), the process proceeds to S150. On the other hand, when the second operating condition is not satisfied (S140;No), S150 is not performed, and the process ends.

The second operating condition is a condition for activating the preventive safety function when the autonomous driving device 10 has the driving intention. The second operating condition is a condition that is more severe than the first operating condition, that is, a condition that is less likely to be satisfied. When the preventive safety function is the collision avoidance control, the following conditions are exemplified as the first operating condition and the second operating condition. For example, the first operating condition may be that the collision margin time is less than a first threshold (e.g., 2.0 seconds), and the second operating condition may be that the collision margin time is less than a second threshold (e.g., 1.0 seconds). The second threshold is less than the first threshold.

Further, the following conditions are exemplified when the preventive safety function is the lane departure suppression control. For example, the first operating condition is that the deviation allowance time of the vehicle 1 is smaller than the threshold value. The second operating condition may be such that the deviation allowance time is smaller than the threshold value and the collision risk is larger than the threshold value. The magnitude of the collision risk may be calculated, for example, based on the distance between the parallel traveling vehicle traveling in the adjacent lane and the vehicle 1, such that the distance between the parallel traveling vehicle and the vehicle 1 becomes smaller. The parallel vehicle is detected by a recognition sensor. The magnitude of the collision risk may alternatively be determined from the lateral speed or acceleration of the vehicle 1. For example, it may be determined that the collision risk becomes larger than the threshold value when the lateral acceleration and the acceleration of the vehicle 1 become larger than the average value of the lateral speed and the acceleration at the time of lane change performed during the manual driving.

In S150, the processor 221 activates the preventive safety function and outputs a control request for steering or deceleration of the vehicle 1 to the travel control device 23. When the preventive safety function is activated, the series of processes ends.

As shown in the above processing, according to the present embodiment, the operating condition of the preventive safety function is changed depending on whether or not the autonomous driving device 10 has the driving intention. When the autonomous driving device 10 does not have an intention to operate, the preventive safety function is activated in response to the establishment of the first operating condition, which is a normal operating condition. In this way, when there is no risk of hindering the travel plan of the autonomous driving device 10, the preventive safety effect for avoiding the danger can be exerted.

On the other hand, when the autonomous driving device 10 has an operation intention, the preventive safety function is activated in response to the establishment of the second operation condition that is more severe than the first operation condition. In a case where the autonomous driving device 10 has an intention to perform vehicle control that causes the establishment of the first operating condition as a driving intention, it is considered that the situation in which the first operating condition is satisfied occurs as a result of the autonomous driving device 10 normally performing the automatic driving. In addition, in a case where the autonomous driving device 10 has an intention of performing vehicle control for eliminating the establishment of the first operating condition as a driving intention, it is considered that the autonomous driving device 10 is trying to eliminate a situation in which the first operating condition is established by controlling the vehicle 1 by itself. Therefore, even in such a case, if the preventive safety function is immediately activated, there is a possibility that a travel plan for automatic driving is hindered. Similarly, in a case where the autonomous driving device 10 has an intention of stopping the preventive safety function, the preventive safety function may be operated more than necessary, thereby hindering the travel plan for automatic driving.

According to the present embodiment, when the autonomous driving device has the driving intention, the preventive safety function does not operate only when the first operating condition is satisfied. As a result, it is possible to prevent the travel plan of the autonomous driving device 10 from being unnecessarily hindered by the operation of the preventive safety function. Even when the autonomous driving device 10 has an intention of driving, the preventive safety function is activated when the second operating condition is satisfied. Therefore, in a necessary situation, the preventive safety function is activated regardless of the state of the automatic driving by the autonomous driving device 10, and the safety of the vehicle 1 can be ensured. In this way, the automatic driving and the preventive safety can be appropriately arbitrated.

### 3. Applicable Scene Example

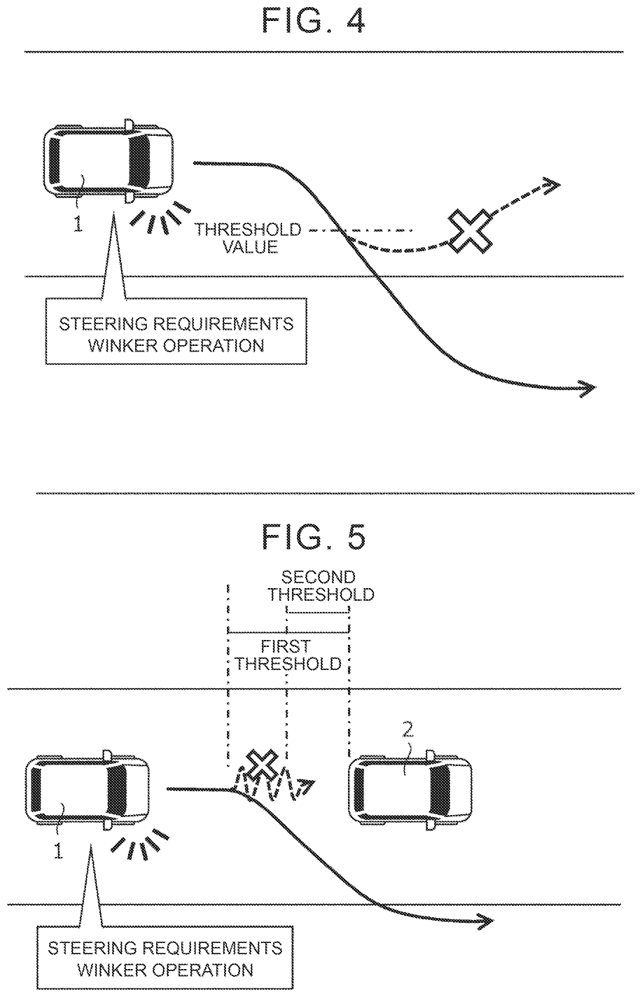

Processing by the preventive safety device 22 will be described with specific scenes shown in FIGS. 4 and 5. In FIG. 4 and FIG. 5, an arrow indicated by a solid line indicates control of the vehicle 1 by the autonomous driving device 10, and an arrow indicated by a dotted line indicates control of the vehicle 1 when the preventive safety function is activated.

FIG. 4 illustrates a scene in which the first operating condition for the lane departure suppression control is satisfied. Here, the first operating condition is that the deviation allowance time is smaller than the threshold value, and the second operating condition is that the deviation allowance time is smaller than the threshold value, and that the collision risk determined by the distance between the vehicle 1 and the vehicle running in parallel is larger than the threshold value.

The vehicle 1 is in autonomous driving, and the autonomous driving device outputs a steering request in a direction deviating from a lane and a winker operation request, the request value being larger than a threshold value. That is, the autonomous driving device 10 has an operation intention. Therefore, the preventive safety device 22 does not activate the preventive safety function only in response to the establishment of the first operating condition, and determines whether or not the second operating condition is established.

Here, since there is no vehicle traveling in the adjacent lane, the collision risk is less than the threshold, and the second operating condition is not satisfied. Therefore, the preventive safety device 22 does not activate the preventive safety function. In this way, the travel plan of the autonomous driving device 10 is not hindered, and the vehicle 1 can be changed in lane by autonomous driving.

FIG. 5 illustrates a scene in which the first operating condition of the collision avoidance control is satisfied. Here, the first operating condition is that the collision margin time is smaller than the first threshold, and the second operating condition is that the collision margin time is smaller than the second threshold. In the example of FIG. 5, the collision margin time with the other vehicle 2, which is an obstacle, is smaller than the first threshold value, and thus the first operating condition is satisfied.

The vehicle 1 is in autonomous driving, and the autonomous driving device outputs a steering request in a direction deviating from a lane in which a required value is larger than a threshold value, and a winker operation request. That is, the autonomous driving device 10 has an operation intention. Therefore, the preventive safety device 22 does not activate the preventive safety function only in response to the establishment of the first operating condition, and determines whether or not the second operating condition is established.

Here, since the collision margin time is not less than the second threshold value, the second operating condition is not satisfied. Therefore, the preventive safety device 22 does not activate the preventive safety function. In this way, the travel plan of the autonomous driving device 10 is not hindered, and the vehicle 1 can be changed in lane by autonomous driving.

As described above, according to the preventive safety device 22 of the present embodiment, it is possible to prevent an unnecessary intervention in the automatic driving from being performed and the travel plan for the automatic driving is hindered. In both of the situations of FIG. 4 and FIG. 5, when the second operating condition is satisfied, the preventive safety device 22 operates the preventive safety function to control braking and steering of the vehicle 1. Therefore, when necessary, the effect of the preventive safety function can be exerted regardless of the intention of driving the autonomous driving device 10. In this way, it is possible to appropriately arbitrate the automatic driving and the preventive safety.

What is claimed is:

1. A preventive safety device having a preventive safety function for control for preventive safety of a vehicle, the preventive safety device comprising one or more processors, wherein the one or more processors
receive an input of a driving signal from an autonomous driving device for performing autonomous driving of the vehicle,
determine whether a first operating condition for activating the preventive safety function is satisfied,
determine, based on the driving signal, whether the autonomous driving device has an intention to perform vehicle control causing satisfaction of the first operating condition, whether the autonomous driving device has an intention to perform vehicle control to eliminate the satisfaction of the first operating condition, or whether the autonomous driving device has an intention to stop the preventive safety function,
activate the preventive safety function in response to the satisfaction of the first operating condition, when the autonomous driving device does not have any of the intentions, and
activate the preventive safety function in response to satisfaction of a second operating condition that is more severe than the first operating condition, when the autonomous driving device has any of the intentions.

2. The preventive safety device according to claim 1, wherein
the control for the preventive safety is to control steering of the vehicle to suppress lane departure of the vehicle, and
the intention of the autonomous driving device to perform the vehicle control causing the satisfaction of the first operating condition is an intention of steering for lane change.

3. The preventive safety device according to claim 1, wherein
the control for the preventive safety is to decelerate the vehicle to avoid collision of the vehicle, and
the intention of the autonomous driving device to perform the vehicle control to eliminate the satisfaction of the first operating condition is an intention of steering or deceleration for avoiding an obstacle.

4. The preventive safety device according to claim 3, wherein
the first operating condition is that a collision margin time of the vehicle is smaller than a first threshold value,
the second operating condition is that the collision margin time is smaller than a second threshold value, and
the second threshold value is smaller than the first threshold value.

5. A vehicle comprising:
the preventive safety device according to claim 1; and
an interface for receiving an input of the driving signal from the autonomous driving device.
